(19) United States
(12) Patent Application Publication
(10) Pub. No.: US 2018/0244965 A1
(43) Pub. Date: Aug. 30, 2018

(54) ADHESIVE COMPOSITION AND METHOD FOR BONDING

(71) Applicant: LORD Corporation, Cary, NC (US)

(72) Inventors: Douglas H. MOWREY, Titusville, PA (US); Brian P. CARNEY, Erie, PA (US); Rebecca S. COWLES, Wattsburg, PA (US); Tarek AGAG, Erie, PA (US)

(73) Assignee: LORD Corporation, Cary, NC (US)

(21) Appl. No.: 15/756,722

(22) PCT Filed: Sep. 21, 2016
(86) PCT No.: PCT/US16/52848

§ 371 Date: Mar. 1, 2018

Related U.S. Application Data
(60) Provisional application No. 62/221,364, filed on Sep. 21, 2015.
(60) Provisional application No. 62/295,854, filed on Feb. 16, 2016.

(51) Int. Cl. C09J 171/12; C09J 11/06; B29C 45/14

(52) U.S. Cl. CPC C09J 171/12; C08K 5/109; B29C 45/14311; C09J 11/06

(57) ABSTRACT

An adhesive for bonding comprising a blocked isocyanate and organic carbonate, and optionally a phenoxy resin, catalyst, metal acetylacetonate, and a process for using such an adhesive to bond elastomers, such as liquid silicone rubber to substrates, such as polycarbonate in an injection molding process.

### CROSS REFERENCE TO RELATED APPLICATIONS

The present application claims priority under 35 U.S.C. § 119(e) from U.S. Provisional Patent Application Ser. No. 62/221,364 filed Sep. 21, 2015, entitled “Adhesive for Injection Molding”, and U.S. Provisional Patent Application Ser. No. 62/295,854 filed Feb. 16, 2016, entitled “Adhesive for Injection Molding”, the disclosures of which are incorporated herein by reference.

### FIELD OF THE INVENTION

The invention relates to an adhesive composition particularly suitable for injection molding operations, preferably those bonding silicone elastomers to polycarbonate, other plastics, metals, and other rigid substrates.

### BACKGROUND OF THE INVENTION

The unique performance of silicon rubbers (silicones) is attributed to the strong silicon-oxygen chemical bond as a repeating unit on its chemical structure. They are odorless, tasteless, do not support bacterial growth and do not stain or corrode other materials. It has outstanding chemical resistance against oxidation and many chemicals, including some acids, alkali solutions, solvents, oils and fuels and water. Silicones withstand a wider range of temperature extremes than most other elastomers. They also have excellent insulating properties as well as flexibility in electrical applications.

One of the commonly used of silicones is an addition-cured liquid silicone rubber (LSR) which is typically provided as a 2-part composition, one containing vinylated silicon polymer and a platinum (Pt) catalyst, and vinylated silicon polymer and Si—H oligomer in the other. Both are mixed just before use, followed by heating for vulcanization at high temperature. Another form of silicone is referred to as HCR (high consistency rubber). In this form, a platinum catalyst, via a two-roll mill, is added to a high viscosity silicone matrix containing hydrosilane and vinyl groups.

Molding addition-cured silicone onto a thermoplastic substrate, particularly polycarbonate, polyester, and polyamide, results in multi material design and performance that combines the best attributes of both substrates. However, it is not an easy task to get robust adhesion of cured silicone to plastics because of low surface energy and lack of functional groups. Therefore, it is necessary to change or improve the surface properties of the plastic without altering the bulk properties. Several techniques are used to modify the surface for improved adhesion, including plasma treatment, mechanical or chemical treatment, and exposure to flames, photons or ion beams. Among these techniques, plasma treatment is a commonly used method to improve the wettability and adhesion. Such treatment leads to surface oxidization, increasing its surface energy and creating roughness. However, there are performance reproducibility issues associated with the use of plasma treatment. Additionally, even the aforementioned surface treatment techniques do not yield a surface that will covalently bond to silicone.

Further, in addition to addition-cured silicone rubber, it would be desirable to provide an adhesive for injection molding peroxide cured elastomers to rigid substrates. Peroxide cured elastomers such as fluoroelastomers (FKM) and hydrogenated nitrile butadiene rubber (HNBR) have broad utility in injection molding, however they can be challenging to bond to rigid substrates like polyamide or steel.

Therefore, an adhesive system that bonds addition-cured silicone to plastics, metals, and other rigid substrates, while eliminating the need for addition surface treatments, would have a significant impact on manufacturing efficiency along with more consistency in bonding.

### SUMMARY OF THE INVENTION

In a first embodiment of the present invention, an adhesive is provided that is capable of bonding a wide assortment of rigid substrates, particularly plastics such as polycarbonate, to liquid silicone rubber (LSR) compounds during the curing step of the rubber. In a preferred embodiment of the present invention, this curing step is initiated in a mold to acquire the desired geometry and can optionally be later finished in a post curing step.

In a further embodiment of the present invention, the adhesive is believed to comprise utility beyond bonding LSR to various substrates, for example lab studies have indicated excellent adhesion between aluminum and TPSiV® elastomer (a unique hybrid of thermoplastic urethane (TPU) and crosslinked silicone rubber available from Dow Corning Company). Additionally, the adhesive of an embodiment of the present invention has utility across a variety of silicone rubbers including high and low temperature cured silicones. Additional substrates have included: polycarbonate, glass, stainless steel, aluminum, nylon, and Arnitel® (a high-performance thermoplastic copolyester available from DSM Engineering Plastics).

In one embodiment of the present invention, the adhesive solves several problems encountered today when using traditional LSR adhesives. Since the adhesives of the present invention are not based on silane chemistry they have improved coated part layover and resistance to high humidity. Parts can be coated with the single coat adhesive by spray or brush techniques and can sit for several days under normal plant conditions and maintain the capability of bonding the dissimilar materials. These adhesives are also capable of bonding a wider range of rigid substrates compared to a silane-based adhesive.

The adhesives of the present invention also provides robust adhesion to the various substrates and often do not require a plasma treating step to improve the surface for bonding. Removing this step is labor saving and saves the end user both time and money. The adhesive is thought to provide robust performance by having the ability to bond many rigid substrates to many different plastic compositions.

In one embodiment of the present invention, an adhesive is provided for bonding a variety of rigid substrates to elastomers, plastics, and TPVs. In a preferred embodiment of the present invention, the adhesive is particularly useful for injection molding operations where the adhesive is applied to a substrate and a liquid silicone rubber (LSR) is applied through an injection molding operation at elevated temperature and pressure. The adhesive provides excellent adhesion to a variety of substrates including nylon, polycarbonate, stainless steel, aluminum, glass, steel and fabric. Further, the range of adhesion to liquid silicone rubbers includes a variety of filled and unfilled, colored or transparent liquid silicone rubber compounds.

In a preferred embodiment of the present invention, an adhesive is provided that bonds various grades of platinum-cured liquid silicone rubber (LSR) to polycarbonate at a low temperature curing temperature (65° C.) without the need for any surface pretreatment process, such as plasma, corona, flame, or solvent treatment. The adhesive system gives bond strengths that exceed the tear strength of the LSR material. The adhesive shows favorable spraying characteristics that allow it to be easily applied with an air powered spray gun. These attributes include low viscosity, fast drying time, good wetting of polymer/metal surfaces, and homogeneous consistency.

In some embodiments of the present invention, the adhesive is provided in a one-pack (1K) system, which is a great advantage relative to two-pack systems (2K) to facilitate the use of the material for the end user. The use of a 1K helps to avoid common operator issues associated with 2K materials, including improper mix ratios, insufficient induction periods, and inadequate mixing. However, in many embodiments of the present invention, the adhesive may be provided as either a one-pack or two-pack system, and the adhesive formulations described herein will generally be described in the as-applied condition, i.e. either a one-pack or the two-pack after mixing.

In one embodiment of the present invention, an adhesive formulation is provided that is particularly effective at bonding peroxide cured elastomers, and solves several problems encountered with previous aqueous adhesives for peroxide cure elastomers. Peroxide cured elastomers such as FKM and HNBR cure through a different mechanism than addition cured materials and therefore the adhesive is modified slightly to beneficially interact with the cure system. First, the adhesive will bond many types of substrates due to the chemistry whereas the previous known compositions are limited in what they can bond. Second, the composition has built in flexibility and toughness not found in previous formulations. Previous formulations required peroxide from the rubber for the adhesive film to cure properly and adhere to the metal substrate and now the inventive adhesive can partially cure without the need for additional peroxide. This makes the inventive adhesive more robust for bonding both substrates and peroxide curing compounds.

In one embodiment of the present invention, the adhesive formulations comprise an aqueous delivery system, which is good for employees and the environment, and can be provided as a single coat system which works without the need for plasma or other surface treatment or priming of the substrate. Additionally, the adhesives of certain embodiments of the present invention demonstrate at least a 72 hour layover resistance while still providing excellent adhesion, and provides greater adhesion that the bulk cohesion of LSR so as to provide rubber-tearing bonds. In alternate embodiments of the present invention, the adhesive formulation is provided in a solvent-based delivery system, which may be more effective at solvating certain constituent materials or swelling the substrates to provide more effective bonding.

In a further embodiment of the present invention, an adhesive for injection or compression molding is provided comprising a phenoxy resin and an organic carbonate. In additional embodiments of the invention, the adhesive further comprises an isocyanate, preferably a blocked isocyanate, and most preferably a blocked isocyanate comprises a self-blocked isocyanate, such as MDI-uretdione. Further optional constituents comprise a metal acetylacetonate, preferably zinc acetylacetonate, a platinum catalyst, an organic carbonate, preferably propylene carbonate, and a polyurethane resin, an allyl methoxy silane, or a bismaleimide.

In another embodiment of the present invention, the polymeric constituents consist essentially of a self-blocked isocyanate, and phenoxy resin, and wherein the adhesive further comprises propylene carbonate, a water or solvent carrier, and optionally a catalyst or metal acetylacetonate.

In yet another embodiment of the present invention, the adhesive comprises a phenoxy resin and organic carbonate and further comprises a self-blocked isocyanate, platinum catalyst, carrier fluid, and optionally at least one of a metal acetylacetonate, allyl methoxy silane, or bismaleimide, wherein, the phenoxy resin is present from about 5 to about 90 weight percent, the organic carbonate is present from about 2 to about 25 weight percent, the self-blocked isocyanate is present from about 1 to about 10 weight percent, the platinum catalyst is present from about 0.01 up to about 1.0 weight percent, the metal acetylacetonate is present up to about 10 weight percent, the allyl methoxy silane is present up to about 10 weight percent, the bismaleimide is present up to about 40 weight percent, and the carrier fluid is present from about 50 to about 90 weight percent, wherein the amounts are based on the total weight of the adhesive composition as applied to a substrate.

In a still further embodiment of the present invention, the adhesive comprises a fluid carrier, 5.00 to 25.00 percent by weight of an organic carbonate, and the following components adding up to 100 percent by weight relative to each other, a phenoxy resin from 50.00 to 99.99 percent by weight, a blocked isocyanate from 0 to 10.00 percent by weight, a metal acetylacetonate from 0.00 to 5.00 percent by weight, and a platinum catalyst from 0.0001 to 0.70 percent by weight. This adhesive is particularly well suited for bonding an assembly comprising a low temperature cured liquid silicone rubber bonded to a rigid substrate.

In another embodiment of the present invention, the adhesive comprises a fluid carrier, 5.00 to 25.00 percent by weight of an organic carbonate, and the following components adding up to 100 percent by weight relative to each other, a phenoxy resin from 50.00 to 99.99 percent by weight, a blocked isocyanate from 10.00 to 50.00 percent by weight, a metal acetylacetonate from 0.00 to 10.00 percent by weight, and a platinum catalyst from 0.006 to 1.00 percent by weight. This adhesive is particularly well suited for bonding an assembly comprising a high temperature cured liquid silicone rubber bonded to a rigid substrate.

In one embodiment of the present invention, the adhesive consists essentially of a phenoxy resin, organic carbonate, a self-blocked isocyanate, platinum catalyst, carrier fluid, and optionally at least one of a metal acetylacetonate, allyl methoxy silane, or bismaleimide; wherein, the phenoxy resin is present from about 5 to about 50 weight percent, the organic carbonate is present from about 2 to about 25 weight percent, the self-blocked isocyanate is present from about 1 to about 10 weight percent, the platinum catalyst is present from about 0.01 up to about 1.0 weight percent, the metal acetylacetonate is present up to about 10 weight percent, the allyl methoxy silane is present up to about 10 weight percent, the bismaleimide is present up to about 40 weight percent, and the carrier fluid is present from about 50 to about 90 weight percent, wherein the amounts are based on the total weight of the adhesive composition as applied to a substrate.

There is also provided in an embodiment of the present invention an adhesive comprising a blocked isocyanate and a phenoxy resin, and optionally a metal acetylacetonate, and bismaleimide. Further, in a preferred embodiment, the polymeric constituents of the adhesive consist essentially of a self-blocked isocyanate, a phenoxy resin, and bismaleimide, and the adhesive further comprises a water or solvent carrier and optional filler materials.

In one embodiment of the present invention, a process for bonding an injection molded article is provided, comprising a) providing in an injection molding cavity a rigid substrate having an adhesive comprising a blocked isocyanate and a phenoxy resin applied thereto, b) injecting into the injection molding cavity a liquid material at a temperature and pressure to allow the liquid material to flow and contact a portion of the adhesive-applied section of the rigid substrate, and c) maintaining the temperature and pressure sufficient to solidify the liquid material and form an adhesive bond between the material and the rigid substrate.

In another embodiment of the present invention, a process for bonding an injection molded article is provided comprising a) providing in an injection molding cavity a rigid substrate having an adhesive comprising a phenoxy resin and an organic carbonate applied thereto, b) injecting into the injection molding cavity a liquid material at a temperature and pressure to allow the liquid material to flow and contact a portion of the adhesive-applied section of the rigid substrate, and c) maintaining the temperature and pressure sufficient to solidify the liquid material and form an adhesive bond between the material and the rigid substrate.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

### DETAILED DESCRIPTION OF THE INVENTION

In one embodiment of the present invention, an adhesive is provided comprising a blocked isocyanate, preferably a self-blocked isocyanate, a phenoxy resin, platinum catalyst, zinc acetylacetonate, propylene carbonate, and either a water or solvent carrier. In a further embodiment of the present invention, the isocyanate material may be omitted entirely for health and environmental considerations when bonding to certain substrates. In a still further embodiment, the adhesive is prepared without the zinc acetylacetonate. These adhesives are particularly well suited for bonding liquid silicone rubbers to rigid substrates such as polycarbonate, thermoplastic copolyester, stainless steel, aluminum and glass.

In another embodiment of the present invention, an adhesive is provided comprising a blocked isocyanate, preferably a self-blocked isocyanate, a water-based phenoxy resin, platinum catalyst, propylene carbonate, and water as a carrier. Optionally a wetting agent or surfactant may be provided. This adhesive finds particular utility in bonding high-temperature cured liquid silicone rubber to rigid substrates such as stainless steel or polycarbonate.

In a further embodiment of the present invention, an adhesive is provided comprising a phenoxy resin, platinum catalyst, propylene carbonate and a solvent carrier, preferably a combination of methyl ethyl ketone and xylene. This adhesive finds particular utility in bonding low-temperature cured liquid silicone rubber to rigid substrates such as polycarbonate.

In another embodiment of the present invention, an adhesive is provided comprising a blocked isocyanate, preferably a self-blocked isocyanate, a phenoxy resin, propylene carbonate, and a polyurethane resin in water.

In an additional embodiment of the present invention, an adhesive is provided comprising a blocked isocyanate, preferably a self-blocked isocyanate, a phenoxy resin, propylene carbonate, and a solvent carrier, preferably cyclohexanone, with an optional glycol ether co-solvent. This adhesive is most useful when bonding TPSiV, polyaryletherketone (PAEK), polyphenylsulphone (PPSU) to rigid substrates such as aluminum and stainless steel.

In another embodiment of the present invention, an adhesive is provided comprising a phenoxy resin, platinum catalyst, zinc acetylacetonate, propylene carbonate, and an allyl methoxy silane, in a water or solvent carrier. In a further embodiment of the present invention, the adhesive further comprises a blocked isocyanate, preferably a self-blocked isocyanate. This adhesive is particularly well suited for bonding a variety of liquid silicone rubbers to polycarbonate substrates.

In a further embodiment of the present invention, an adhesive is provided comprising a blocked isocyanate, preferably a self-blocked isocyanate, a phenoxy resin, bismaleimide, and water. This adhesive is capable of bonding peroxide curing elastomers to a variety of substrates both rigid and flexible during the cure cycle of the rubber. Elastomers include but not limited to the following: ethylene propylene diene monomer (EPDM), FKM, HNBR, nitrile rubber (NBR), and silicone. Substrates include but not limited to the following: plastics (polyamide (PA), polycarbonate (PC), ARNITEL, TPSIV, PAEK, PEEK, and others), glass, fabric, stainless steel, zinc phosphatized steel, and aluminum. Notably, this embodiment does not require the metal acetylacetonate or organic carbonate that are employed in many and most other embodiments, respectively.

In one embodiment of the present invention, the adhesive comprises a self-blocked isocyanate. Self-blocked isocyanates are also referred to as internally-blocked isocyanates and commonly comprise dimerized diisocyanates.

Bis (cyclic ureas) are blocked aliphatic diisocyanates and are preferred in some embodiments because no by-products are formed upon thermal release of the reactive isocyanate groups. These comprise compounds that can be referred to as self-blocked isocyanates. Examples of these bis-cyclic ureas are described by Ulrich, ACS Symp. Ser. 172 519 (1981), Sherwood, J. Coat. Technol. 54 (689), 61 (1982) and Kirk-Othmer Encyclopedia of Chemical Technology, Third Edition, Volume 23, p. 584 all of which are incorporated herein by reference. As an example of such an internally-blocked isocyanate, uretdione-bound self-blocked isophorone diisocyanate, which is marketed from Huls Co. under a tradename “IPDI-BF 1540”, may be cited.

In a further embodiment of the present invention, the “internally blocked isocyanates” comprise the dimerized diisocyanates discussed above, however there may be some isocyanate functionalities on the ends of the molecule that are partially blocked or unblocked. These functionalities may react slowly with water and decrease shelf life in aqueous formulations, however the primary “internally blocked” isocyanate functionality remains reactive in the as-applied adhesive formulation and is available for bonding.

In an alternate embodiment of the present invention, the self-blocked isocyanate comprises dimeric isocyanates such as dimeric toluene diisocyanate (TDI-uretdione), dimeric methylene diphenyl diisocyanate (MDI-uretdione) or a mixture thereof. An example of a uretdione of MDI is GRILBOND A2BOND available from EMS-Griltech (Switzerland), and an example of a uretdione of TDI is ADOLINK TT available from Rhein Chemie Rheinau GmBH (Mannheim, Germany).

In an additional embodiment of the present invention, the isocyanate comprises a traditional blocked isocyanate. Blocked isocyanates are typically formed by the reaction of an isocyanate with either an active hydrogen or methylene compound such as malonic esters. When these blocked products are heated, the blocking agent is released and the isocyanate reacts when in the presence of an isocyanate-reactive species such as a phenoxy resin.

In a further embodiment of the present invention, the isocyanates can be prepared in aqueous or solvent carriers. The isocyanates of the aqueous adhesive compositions of the present invention can be rendered hydrophilic by reaction with cationic, anionic and/or nonionic compounds containing isocyanate-reactive groups, or by admixture with external emulsifiers, or both, as is known in the art. The NCO functional groups of the isocyanate can also be partially or substantially totally blocked using known blocking agents and processes to aid in water dispersibility of the isocyanate.

Also, for solvent-based embodiments of the present invention, the carrier solvent may act as an additional block of the isocyanate further adding to the stability of the system.

In a further embodiment of the present invention, the adhesive comprises essentially no isocyanate, and in another embodiment of the present invention, the adhesive comprises no isocyanate. In such an embodiment, depending upon the substrates to be bonded, the isocyanate functionality is not required to produce a robust, rubber tearing bond.

Phenoxy reins are commercially important thermoplastic polymers derived from bisphenols and epichlorohydrin. Their molecular weights are higher, i.e., at least about 45,000, than those of conventional epoxy resins, i.e., 8,000 maximum. They lack terminal epoxide functionality and are therefore thermally stable and can be fabricated by conventional thermoforming techniques. Phenoxy resins are prepared by reaction of high purity bisphenol A with epichlorohydrin in a 1:1 mole ratio. Solution polymerization may be employed to achieve the molecular weight and processability needed.

A suitable example of a phenoxy resin that may be used in the present invention is a polymer of bisphenol “A”, specifically, diglycidyl ethers of bisphenol “A”. Suitable for use in the present invention as the phenoxy resin is that sold as Phenoxy Resin PKHW-35, and manufactured by Gabriel Performance Products in Ohio, USA. PKHW-35 is an amine-neutralized, carboxylated phenoxy resin in water, and is a waterborne product that is surfactant-free, colloidal in natured with excellent emulsion stability from 0° C. to 55° C., exhibiting a high degree of consistency in viscosity and solids, and having up to 40 percent solids by weight.

In another embodiment of the present invention, a solvent-soluble phenoxy resin is employed for use in a solvent-based adhesive. Solvent-soluble phenoxy resins are known in the art from a number of producers, however particularly suitable examples of phenoxy resins for solvent-based adhesives include the solid PKHH grade sold by Phenoxy Associates or PKHS-40, which is a PKHH grade pre-dissolved in methylethyl ketone (MEK).

Further examples of suitable amine neutralized, carboxylated phenoxy resins are those phenoxy resins which have been carboxylated with lower alkanoic acids having 1 to 6 carbon atoms such as formic acid, acetic acid, propionic acid, butyric acid, pentanoic acid and hexanoic acid, which have been amine neutralized, by reaction with ammonia or ammonium hydroxide.

In one embodiment of the present invention, the adhesive further comprises a catalyst. The catalyst comprises a typical metal hydrosilylation catalyst and used in an amount specified below which is sufficient to effect the cure of the adhesive composition. In a preferred embodiment of the present invention, the catalyst comprises a platinum cyclovinylmethylsiloxane complex. An additional suitable platinum catalyst is available from Gelest, Inc. under the SIP 6830 designation, also known as Karstedt Catalyst, or a COD catalyst such as dichloro(1,5-cyclooctadiene)platinum(II), available from Sigma-Aldrich, Missouri, USA.

In another embodiment of the present invention, suitable catalysts include but are not limited to chloroplatinic acid, Karstedt's catalyst (Pt₂{[(CH₂═CH)Me₂Si]₂O}₃), Ashby's catalyst {[(CH₂═CH)MeSiO]₄}₃Pt, Wilkinson's catalyst [tris(triphenylphosphine)rhodium (1) chloride], polymer bound Wilkinson's catalyst, tris(triphenylphosphine)iridium (I) chloride, chloroplatinic acid/octanol complex, platinum cyclovinylmethylsiloxane complex (Ashby-Karstedt catalyst), platinum carbonyl cyclovinylmethylsiloxane complex, bis(benzonitrile)dichlorpalladium (II), tetrakis(triphenylphosphine)palladium (0), palladium 2,4-pentanedionate, iridium 2,4-pentanedionate, iridium cyclooctadiene chloride, Pt metal, Pd metal, Ir metal, and Rh metal.

In another aspect of the present invention, it has been found that improved performance can be obtained by employing one or more co-catalysts. While typically employed in embodiments where a catalyst is present in the adhesive formulation, co-catalysts may also be employed in adhesive formulations without a primary catalyst. These co-catalysts are preferable based on the elements from Groups VIIB, VIII, IB, IIB, IVA or VA of the Periodic Table of the Elements such as manganese, cobalt, nickel, copper, zinc, zirconium germanium, antimony, or bismuth, especially compounds based on an element from the foregoing groups metals, such as bivalent metals, and particularly chelates of metals, or oxides or salts of these metals and especially carbonate salts are preferred. Zinc, bismuth, and antimony are especially preferred metallic elements, with zinc being most preferred.

Representative salts of these cocatalyst metals are based on inorganic acids, carboxylic acids, hydroxy carboxylic acids, alcohols, glycols and phenols.

Representative carboxylic acids include both mono and dicarboxylic acids containing from 1 to about 20 carbon atoms and include aliphatic and cycloaliphatic saturated or unsaturated acids, and aromatic acids, and include formic, acetic, acrylic, methacrylic, propionic, butyric, hexanoic, octanoic, decanoic, stearic, oleic, eiconsanoic and benzoic acids. Examples of dicarboxylic acids include oxalic, malic, maleic, succinic, sebacic and the various isomeric phthalic acids. Typical hydroxy carboxylic acids preferably contain from 2 to about 20 carbon atoms and include hydroxy acetic, lactic, citric, tartaric, salicylic, and gluconic acids.

Inorganic acids or the mineral acids include carbonic acid, halogen acids such as hydrochloric, hydrobromic, and hydriodic acids, nitrogen acids, sulfur acids and phosphorus acids, all of which are known in the art.

The alcohols comprise straight chain or branched chain mono- or polyhydroxy alcohols, alkyl substituted or unsubstituted mononuclear or polynuclear mono or polyhydroxy cycloaliphatic alcohols and the like containing from 1 to about 20 carbon atoms. The phenols comprise alkyl substituted or unsubstituted mononuclear or polynuclear mono or polyhydroxy phenols.

The carbonates of the aforesaid metals may exist as pure carbonates or as basic carbonates which are believed to be mixtures of the carbonate and the oxide or hydroxide of the metal in a single molecule and include metal carbonates such as basic zinc carbonate, basic copper carbonate and the like.

The chelates of the aforesaid metals that may be employed may be based on any metal chelating compounds known in the art but typically comprise beta-diketones such as acetyl acetone to provide the acetylacetonates of the metals.

Metal catalysts that are generally most suitable as cocatalysts are the ones that are soluble in the formulation especially if soluble in the functional compound, e.g. the polyol resin or soluble in the solvent if the formulation uses a solvent.

Some specific metal catalysts that may be employed comprise zinc carbonate (basic), zinc acetylacetonate, zinc acetate, copper acetylacetonate, iron acetylacetonate, nickel acetylacetonate, zinc acetate, zinc lactate, and copper acetate. Such suitable metal cocatalysts are generally described by Leiner and Bossert in U.S. Pat. No. 4,395,528.

In one embodiment of the present invention, the adhesive formulation further comprises an organic carbonate which is believed to lower the temperature at which the self-blocked urethane begins to react. Examples of such carbonates are dimethyl carbonate, diethyl carbonate, dipropyl carbonate, dibutyl carbonate, dipentylcarbonate, dihexyl carbonate, dioctyl carbonate, diphenyl carbonate, diallyl carbonate, ditolyl carbonate, butyl phenylcarbonate, 1,3-dioxolan-2-one (ethylene carbonate), 4-methyl-1,3-dioxolan-2-one (propylene carbonate), 4-ethyl-1,3-dioxolan-2-one (butylene carbonate), 4-propyl-1,3-dioxolan-2-one, 4-vinyl-1,3-dioxolan-2-one, 1,3-dioxan-2-one (trimethylenecarbonate), 5-dimethyl-1,3-dioxan-2-one (neopentylene carbonate), 4-methoxy-methyl-1,3-dioxolan-2-one, 4-ethoxymethyl-1,3-dioxolan-2-one, 4-phenoxy-methyl-1,3-dioxolan-2-one, 4-acetoxymethyl-1,3-dioxolan-2-one, erythritol bis(carbonate) and 2,5-dioxahexanoate.

Organic carbonates used are preferably ones having a cyclic structure such as 1,3-dioxolan-2-one (ethylene carbonate), 4-methyl-1,3-dioxolan-2-one (propylene carbonate), 4-ethyl-1,3-dioxolan-2-one (butylene carbonate) or glycerol carbonates in which the O-bonded hydrogen of the exocyclic —CH₂OH group has been replaced by NCO-unreactive substituents such as optionally substituted alkyl, acyl, aryl or aralkyl groups.

In a further embodiment of the present invention, the organic carbonate may be removed and a cyclic sulfone or sulfolane material employed. The cyclic sulfone may interfere with the embodiments employing a platinum catalyst, and therefore is preferred only in non-catalyzed adhesive embodiments.

In one embodiment of the present invention, the adhesive further comprises an allyl silane. The allyl silane may comprise a mono, di or triallyl silanes. In a further embodiment of the present invention, the adhesive comprises an allyl alkoxysilane. In a preferred embodiment of the present invention, diallyl alkoxysilanes are provided, and most preferred diallyl methoxy- and ethoxy-silanes. In another embodiment of the present invention, the adhesive comprises a vinyl alkoxysilane. From the vinyl alkoxysilanes, in particular vinyl triethoxysilane and/or vinyl trimethoxysilane are provided.

In a further embodiment of the present invention, the adhesive further comprises a silicone-modified polyester polyurethane. In a preferred embodiment of the present invention, the silicone-modified polyester polyurethane comprises an elongation of greater than 200% when measured at a rate of 20 inches/minute (50.8 cm/min). One example of such a silicone-modified polyester-based, water-borne polyurethane dispersion is Hauthane L-2857 (available from C.L. Hauthaway & Sons Corporation, Massachusetts, U.S.A).

In another embodiment of the present invention, the adhesive further comprises a maleimide compound. The maleimide compound comprises any compound containing at least two maleimide groups. The maleimide groups may be attached to one another or may be joined to and separated by an intervening divalent radical such as alkylene, cyclo-alkylene, epoxydimethylene, phenylene (all 3 isomers), 2,6-dimethylene-4-alkylphenol, or sulfonyl. An example of a maleimide compound wherein the maleimide groups are attached to a phenylene radical is m-phenylene bismaleimide and is available as HVA-2 from E.I. Du Pont de Nemours & Co. (Delaware. U.S.A.)

The maleimide compound crosslinker may also be an aromatic polymaleimide compound. Aromatic polymaleimides having from about 2 to 100 aromatic nuclei wherein no more than one maleimide group is directly attached to each adjacent aromatic ring are preferred.

Such aromatic polymaleimides are common materials of commerce and are sold under different trade names by different companies, such as BMI-M-20 and BMI-S aromatic polymaleimides supplied by Mitsui Chemicals. Incorporated.

In embodiments of the present invention, the adhesive formulations are provided in a carrier fluid. The carrier fluid helps to disperse the active constituent materials and helps during application of the adhesive, i.e. sprayability, wettability, and the like. In one embodiment of the invention, water is provided as the carrier fluid. In another embodiment of the present invention, a glycol-ether or glycol-based carrier fluid, such as propylene glycol is provided.

In another embodiment of the present invention, the adhesive is provided in a solvent based system. Non-limiting examples of suitable solvents are solvents which are inert towards isocyanate groups, such as hexane, toluene, xylene, chlorobenzene, ethyl acetate, butyl acetate, diethylene glycol dimethyl ether, dipropylene glycol dimethyl ether, ethylene glycol monomethyl or monoethyl ether acetate, diethylene glycol-ethyl and butyl ether acetate, propylene glycol monomethyl ether acetate, 1-methoxyprop-2-yl acetate, 3-methoxy-n-butyl acetate, propylene glycol diacetate, acetone, methyl ethyl ketone, methyl isobutyl ketone, cyclohexanone, lactones such as β-propiolactone, γ-butyrolactone, ε-caprolactone and ε-methyl caprolactone, for example, but also solvents such as N-methylpyrrolidone and N-methylcaprolactam, 1,2-propylene carbonate, methylene chloride, dimethyl sulphoxide, triethyl phosphate or any mixtures of such solvents. In a preferred embodiment of the present invention, the solvent-based adhesive formulation comprises xylene, methylethyl ketone, cyclohexanone or mixtures thereof as the primary carrier.

In one embodiment of the present invention, the adhesive is provided in an aqueous carrier with the optional inclusion of small amounts of co-solvent. In another embodiment of the present invention, the adhesive is provided in a solvent carrier system, though small amounts of water may be present in an emulsion or colloidal mixture.

In embodiments of the present invention, the adhesive composition may optionally comprise other well-known additives including plasticizers, fillers, pigments, surfactants, dispersing agents, wetting agents, rheology modifiers, reinforcing agents and the like.

In an embodiment of the present invention, the adhesives are applied to the rigid substrate through common application procedures such as spray application, brush application, or a dip process. The adhesive is preferably applied in a uniform wet film and hot air is employed to assist the drying and removal of the carrier fluid. The dry film thickness is targeted for about 0.20-1.0 mils or 5 to 25 microns.

Bonded assemblies are prepared using a compression or injection molding process. For compression molding, a mold having two separate cavities is employed. The rigid substrate having the dry adhesive film coating is placed in the preheated mold and the plastic/elastomer to be bonded is placed on top in the cavity. The hot mold is closed and placed in a hydraulic press and clamped under a known pressure. Once cured, the bonded assemblies are removed from the mold. Once the bonded assemblies cooled to room temperature they can be manually and visually tested for bond quality. Injection molding is similar, except the plastic/elastomer is injected into the mold cavity as a liquid and an elevated temperature and pressure are maintained until the assembly is cured and bonded.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

### EXAMPLES

Throughout the examples, the adhesives were prepared, applied, bonded, and tested as described below, unless otherwise described in the individual example.

Adhesive Manufacture: As will be appreciated by one of skill in the art, some of the components need to be ground to a smaller particle size via bb mill, sandmill, or kady mill, while other components can be rolled in since they are in solution or already dispersed in water as received. The adhesives were prepared according to the formulations below, and applied, bonded, cured as described below.

Adhesive Application: Typical application of the prepared adhesive is to spray apply the mixed adhesive to the rigid substrate and allowed to dry before the in-mold bonding step. Dry film thickness requirements will vary but typical dry film thickness is between 5 and 25 microns or 0.20-1.00 mils.

Bonding/Curing: Bonding conditions can vary depending upon the particular processing characteristics of the non-rigid material (elastomer, plastic, TPV) that is being bonded to the rigid substrate. In the present example, the LSR samples are bonded in a mold with a temperature preset at 257° F. (125° C.) and once the LSR is in the mold and closed under pressure a cure cycle of approximately 5 minutes is enough for cure and bonding to have taken place.

Testing Parameters: Typically bond quality is tested in several manners, such as those outlined in ASTM 429B. Testing took place using an Instron®-type test apparatus where the rigid substrate is held in place with fixturing and the elastomer, LSR, or TPSiV is peeled away from the substrate at an angle to 90 or 180 degrees at a speed of 30 mm/min to 300 mm/min. This method provides a value for the force needed to cause two materials to separate and again the failure mode is visually examined to determine the percentage of “rubber” (non-rigid substrate) that is left on the rigid substrate.

As outlined in the standard rubber bonding test method ASTM D 429, the terminology of the results as reported include: R=indicates failure of the rubber, RC=indicates failure at the rubber/rubber-primer interface; CP=indicates failure at the rubber-primer/substrate-adhesive interface; M=indicates failure at the substrate/substrate-adhesive interface. Mixed results will indicate the surface area percentage of failure as split between tow failure modes, for example 50% R, 50% RC indicates a failure mode where 50% of the rubber remains on the coupon, and 50% of the coupon is free of rubber, yet the substrate-adhesive remains on the coupon.

### Example 1

In this example, a 2-part aqueous adhesive was prepared and tested according to the procedures above.

Adhesive 1-1

| | Weight |
|---|---|
| Constituent | Percent |
| Phenoxy resin | 30 |
| Zinc Acetylacetonate | 3.0 |
| Platinum Catalyst | 0.5 |
| Additives/thickeners | 0.5 |
| Water | 66 |
| Total A | 100 |
| MDI-Uretdione | 13 |
| Propylene Carbonate | 28 |
| Glycol ether (Dowanol PM) | 29 |
| Additives/thickeners | 2 |
| Water | 28 |
| Total B | 100 |

The Adhesive 1-1 was tested against a variety of rigid substrates with ShinEtsu 1950-70 LSR injection molded thereto. Preliminary bonding results were as follows:

| | Peel Strength | Rubber Tear |
|---|---|---|
| | (N/cm) | (%) |
| Lexan 121 | 73 | 100 |
| Lexan 121 Black | 65 | 100 |
| 304 Stainless Steel | 55 | 95 |
| Aluminum | 44 | 91 |
| Glass | 51 | 100 |

The same adhesive was then employed to bond three common LSR products to certain common rigid substrates, with preliminary bonding results as follows:

| | | LSR 1 | LSR 2 | LSR 3 |
|---|---|---|---|---|
| Lexan 121 | Peel Strength (N/cm) | 70 | 70 | 77 |
| | Rubber Retention (%) | 100 | 100 | 100 |
| Lexan 505RU | Peel Strength (N/cm) | 81 | 78 | 58 |
| | Rubber Retention (%) | 100 | 95 | 100 |
| Arnitel EM400 | Peel Strength (N/cm) | 62 | 56 | 68 |
| | Rubber Retention (%) | 60 | 90 | 100 |
| Arnitel EM460 | Peel Strength (N/cm) | 75 | 58 | 50 |
| | Rubber Retention (%) | 98 | 68 | 95 |

### Example 2

A solvent-based adhesive was prepared in a 2-part system, which was mixed at a ratio of 10:1 prior to application to the rigid substrate.

Adhesive 2-1a

| | Weight |
|---|---|
| Constituent | Percent |
| Phenoxy resin | 9.5 |
| MDI-Uretdione | 4.2 |
| Zinc Acetylacetonate | 1.0 |
| Propylene Carbonate | 5.1 |
| Glycol ether (Dowanol PM) | 20.7 |
| Methyl ethyl ketone | 49 |
| Cyclohexanone | 10.5 |

Adhesive 2-1b

| | Weight |
|---|---|
| Constituent | Percent |
| Platinum Catalyst | 2.5 |
| Xylene | 97.5 |

The adhesive was mixed and applied to the rigid substrates noted below, dried, and bonded in a mold to two of the same LSRs as in Example 1, with the following preliminary bonding results:

| | | LSR 2 | LSR 3 |
|---|---|---|---|
| Lexan 121 | Peel Strength (N/cm) | 76 | 58 |
| | Rubber Retention (%) | 100 | 100 |
| Lexan 505RU | Peel Strength (N/cm) | 85 | 50 |
| | Rubber Retention (%) | 100 | 95 |
| Arnitel EM400 | Peel Strength (N/cm) | 84 | 62 |
| | Rubber Retention (%) | 100 | 90 |
| Arnitel EM460 | Peel Strength (N/cm) | 60 | 68 |
| | Rubber Retention (%) | 98 | 100 |

### Example 3

In this example, an isocyanate-free adhesive was prepared according to the formulation below. While this adhesive may be preferred for some uses as being isocyanate-free, it may lack utility across a broad range of substrates and liquid silicone rubbers may be more limited than the isocyanate-containing embodiments.

| | Weight |
|---|---|
| Constituent | Percent |
| Phenoxy resin | 22.5 |
| Zinc Acetylacetonate | 1.75 |
| Propylene Carbonate | 14 |
| Platinum Catalyst | 0.25 |
| Glycol ether (Dowanol PM) | 13 |
| Water | 48 |
| Additives/thickeners | 0.5 |

This adhesive was used to bond a liquid silicone rubber to a thermoplastic copolyester elastomer, and was tested according to the procedures above. The average peel value was 77.44N/cm and the average rubber retention was 96.25 percent, indicating a robust bond employing an isocyanate-free adhesive according to an embodiment of the present invention.

### Example 4

Adhesive 4-1 (10:1 mix ratio)

| | Weight |
|---|---|
| Constituent | Percent |
| MDI-Uretdione | 2.0 |
| Phenoxy Resin (PKHH-type) | 12.5 |
| Propylene Carbonate | 5.0 |
| Glycol Ether | 6.0 |
| MEK/Cyclohexanone | 75.5 |
| Total A | 100 |
| Platinum Catalyst | 2.5 |
| Xylene | 97.5 |
| Total B | 100 |

Adhesive 4-2, 4-2*

| | Weight |
|---|---|
| Constituent | Percent |
| MDI-Uretdione | 2 |
| Phenoxy Resin (PKHH-type) | 11.5 |
| Propylene Carbonate | 4.5 |
| Glycol Ether | 5.5 |
| Platinum Catalyst | 0.25 |
| Xylent/MEK/Cyclohexanone | 76.25 |

*a second solvent based adhesive comprising three times amount of platinum catalyst was also prepared.

Adhesive 4-3 (5:1 mix ratio)

| | Weight |
|---|---|
| Constituent | Percent |
| Phenoxy resin (PKHW) | 49.5 |
| MDI-Uretdione | 7.5 |
| Zinc Acetylacetonate | 2 |
| Glycol ether (Dowanol PM) | 2 |
| Additives/thickeners | 1 |
| Water | 38 |
| Total A | 100 |
| Propylene Carbonate | 98 |
| Platinum Catalyst | 2 |
| Total B | 100 |

Adhesive 4 (4:1 mix ratio)

| | Weight |
|---|---|
| Constituent | Percent |
| Phenoxy resin | 45.75 |
| MDI-Uretdione | 6.25 |
| Additives/thickeners | 1 |
| Water | 47 |
| Total A | 100 |
| Propylene Carbonate | 99 |
| Platinum Catalyst | 1 |
| Total B | 100 |

All five formulations were prepared and used to bond a thermoplastic copolyester to two different LSRs. Good primary adhesion was shown with both LSRs across all adhesives.

| | ShinEtsu 150-70 | Xiameter RBL9200-70 |
|---|---|---|
| | Peel strength (N/cm) | Peel strength (N/cm) |
| Adhesive 4-1 | 76 | 58 |
| Adhesive 4-2 | 56 | 19 |
| Adhesive 4-2* | 67 | 59 |
| Adhesive 4-3 | 65 | 67 |
| Adhesive 4-4 | 56 | 61 |

Further, Adhesive 4-1 (solvent) and Adhesive 4-4 (aqueous) were used to bond a LSR to Lexan 121 and subjected to ageing at 40° C. and 90% relative humidity. Both adhesive formulations exhibited excellent layover resistance.

### Example 5

This example demonstrates the effectiveness of adhesives according to embodiments of the present invention in bonding to high temperature cured LSR. The amount of self-blocked isocyanate was varied to determine how critical this component is to effective bonding of LSR to stainless steel (SS) and polycarbonate (PC).

| | Ad 5- | Ad 5- | Ad 5- | Ad 5- | Ad 5- | Ad 5- | Ad 5- |
|---|---|---|---|---|---|---|---|
| | 1 | 2 | 3 | 4 | 5 | 6 | 7 |
| Phenoxy PKHW-35@ | 51.74 | 49.14 | 46.54 | 43.94 | 41.34 | 38.74 | 36.14 |
| 33.0% tsc in water | | | | | | | |
| Self-Blocked Isocyanate | 0 | 1 | 2 | 3 | 4 | 5 | 6 |
| Pt Catalyst | 0.16 | 0.16 | 0.16 | 0.16 | 0.16 | 0.16 | 0.16 |
| Propylene Carbonate | 15.7 | 15.7 | 15.7 | 15.7 | 15.7 | 15.7 | 15.7 |
| Wetting agent | 0.16 | 0.16 | 0.16 | 0.16 | 0.16 | 0.16 | 0.16 |
| Water | 32.24 | 33.84 | 35.44 | 37.04 | 38.64 | 40.24 | 41.84 |
| TOTAL | 100 | 100 | 100 | 100 | 100 | 100 | 100 |

The adhesives were spray applied to the rigid substrate (either stainless steel or polycarbonate), at a dry film thickness of about 10 microns, dried at 65° C. for 15 minutes and then placed in a mold and the LSR was injected and the assemblies cured for 5 minutes at 125° C. For LSR, this is considered to be a “high temp” cure.

The assemblies were tested via 180 peel angle at 12 inches/min, then the parts were visually examined after testing for rubber retention.

Liquid High Temp Silicone 1

| | Primary Adhesion SS | | | |
|---|---|---|---|---|
| | Peel | | Primary Adhesion PC | |
| | Strength | Rubber | Peel Strength | Rubber |
| | (pli) | Retention (%) | (pli) | Retention (%) |
| Adhesive 5-1 | 26 | 88 | 0 | 0 |
| Adhesive 5-2 | 50 | 100 | 0 | 0 |
| Adhesive 5-3 | 49 | 100 | 20 | 100 |
| Adhesive 5-4 | 54 | 100 | 23 | 100 |
| Adhesive 5-5 | 52 | 100 | 19 | 100 |
| Adhesive 5-6 | 56 | 100 | 26 | 100 |
| Adhesive 5-7 | 39 | 100 | 18 | 100 |

Liquid High-Temp Silicone 2

| | Primary Adhesion SS | | | |
|---|---|---|---|---|
| | Peel | | Primary Adhesion PC | |
| | Strength | Rubber | Peel Strength | Rubber |
| | (pli) | Retention (%) | (pli) | Retention (%) |
| Adhesive 5-1 | 48 | 90 | 11 | 0 |
| Adhesive 5-2 | 44 | 92 | 12 | 5 |
| Adhesive 5-3 | 55 | 100 | 20 | 50 |
| Adhesive 5-4 | 46 | 100 | 19 | 55 |
| Adhesive 5-5 | 43 | 100 | 18 | 50 |
| Adhesive 5-6 | 37 | 100 | 24 | 90 |
| Adhesive 5-7 | 43 | 100 | 23 | 80 |

These results demonstrate the importance of the internally-blocked isocyanate for high temperature cured LSR. Without the internally-blocked isocyanate (Adhesive 5-1) there is no adhesion to polycarbonate and reduced adhesion to stainless steel. As the amount of isocyanate increases (Adhesives 5-2 through 5-7, respectively), the bonding performance generally increases.

### Example 6

This example demonstrates the effectiveness of adhesives according to embodiments of the present invention in bonding to low temperature cured LSR. Additionally, in one formulation the propylene carbonate was removed to demonstrate the importance of this material in providing a robust bond between low temperature silicone and polycarbonate.

| | Adhesive | Adhesive |
|---|---|---|
| | 6-1 | 6-2 |
| Phenoxy PKHH | 11.33 | 11.33 |
| Pt (catalyst) | 0.0007 | 0.0007 |
| Propylene Carbonate | 18.52 | 0 |
| MEK/Xylene | 70.15 | 88.67 |
| TOTAL | 100 | 100 |

The adhesives were spray applied to the rigid substrate (polycarbonate), at a dry film thickness of about 10 microns, dried at 65° C. for 15 minutes and then placed in a mold and the LSR was injected and the assemblies cured for 5 minutes at 65° C. For LSR, this is considered to be a “low temp” cure.

The assemblies were tested via 180 peel angle at 12 inches/min, then the parts were visually examined after testing for rubber retention.

| | Liquid Low | | | |
|---|---|---|---|---|
| | Temp Silicone 1 | | Liquid Low Temp Silicone 2 | |
| | Peel Strength | Rubber | Peel Strength | Rubber |
| | (pli) | Retention (%) | (pli) | Retention (%) |
| Adhesive | 18 | 100 | 41 | 100 |
| 6-1 | | | | |
| Adhesive | 0 | 0 | 0 | 0 |
| 6-2 | | | | |

The results above show the effectiveness of these adhesives to bond low temp curing liquid silicone rubber to a polycarbonate substrate, and demonstrates the importance of propylene carbonate to the adhesive formulation when bonding low temperature cured LSR to polycarbonate.

### Example 7

The following two adhesives were prepared using a diallyl methoxy silane to enhance bonding to liquid silicone rubbers. The adhesives were prepared in a solvent and aqueous carrier fluid and used to bond a high temp and low temp LSR to polycarbonate.

Adhesive 7-1

| | Weight |
|---|---|
| Constituent | Percent |
| Diallyl Methoxy Silane | 2.5 |
| PKHH Resin | 5.0 |
| Platinum Catalyst | 0.15 |
| MDI-Uretdione | 2.0 |
| ZnAcAc | 0.30 |
| Methyl Ethyl Ketone | 15 |
| Dowanol PM | 67.76 |
| Organic Carbonate | 7.24 |
| Dapro W-77 | 0.05 |
| Total | 100 |

Adhesive 7-2

| | Weight |
|---|---|
| Constituent | Percent |
| Diallyl Methoxy Silane | 2.5 |
| PKHW-35 Resin | 5 |
| Platinum Catalyst | 0.15 |
| MDI-Uretdione | 2 |
| ZnAcAc | 0.3 |
| Water | 68.89 |
| Dowanol PM | 6.7 |
| Organic Carbonate | 14.41 |
| Dapro W-77 | 0.05 |
| Total | 100 |

Adhesives 7-1 and 7-2 were spray applied to a polycarbonate substrate, then pre-baked under the time and temperature conditions below. The adhesive coated polycarbonate coupon was then placed in a mold and a high-temp LSR introduced and held at 125° C. for 5 minutes to cure the adhesive/LSR. Results were as follows:

High Temp LSR

| | Average | | | |
|---|---|---|---|---|
| | of Max | Average of Avg | Average | Average |
| | Peel (lbs) | Peel (lbs) | of R | of TR |
| 110° C./15 mins | | | | |
| Adhesive 7-1 | 43.7 | 20.45 | 100 | 0 |
| Adhesive 7-2 | 21.4 | 12.35 | 50 | 50 |
| 60° C./15 mins | | | | |
| Adhesive 7-1 | 22.45 | 12.1 | 50 | 50 |
| Adhesive 7-2 | 22.2 | 9.2 | 10 | 25 |
| 80° C./15 mins | | | | |
| Adhesive 7-1 | 33.2 | 18.8 | 100 | 0 |
| Adhesive 7-2 | 33.45 | 13 | 0 | 100 |

Adhesive 7-1 was spray applied to a polycarbonate substrate, then pre-baked under the time and temperature conditions below. The adhesive coated polycarbonate coupon was then placed in a mold and a low-temp LSR introduced and held at 65° C. for 5 minutes to cure the adhesive/LSR. Results were as follows:

Low Temp LSR

| | Average of Max | Average of Avg | |
|---|---|---|---|
| | Peel (lbs) | Peel (lbs) | Average of R |
| 110° C./15 mins | | | |
| Adhesive 7-1 | 19.8 | 13.2 | 100 |
| 60° C./15 mins | | | |
| Adhesive 7-1 | 18.9 | 12.95 | 80 |
| 80° C./15 mins | | | |
| Adhesive 7-1 | 16.3 | 11.9 | 87.5 |

### Example 8

In this example, adhesive according to embodiments of the present invention were employed to bond a peroxide cured material to a rigid substrate. The adhesives were prepared in accordance with the procedures above, spray applied to the rigid substrate and dried, then compression molded for 7 minutes at 175° C. (347° F.) with different FKM rubbers. The adhesives are described below in terms of dry weight percent, i.e. the amount of constituent material remaining on the rigid substrate after drying. The aqueous adhesives were prepared in water to a solids concentration of 22 weight percent.

Aqueous Adhesives

| | AQ | | |
|---|---|---|---|
| | PERCENT DRY WEIGHT | | |
| Raw Materials | 8-1 | 8-2 | 8-3 |
| Phenoxy resin | 79.88 | 69.88 | 69.88 |
| A2Bond RD | 10 | 10 | 15 |
| Marasperse | 0.12 | 0.12 | 0.12 |
| M-20 | 10 | 10 | 10 |
| (polybismaleimide) | | | |
| Phenolic Novolak | | 10 | 5 |
| Resin | | | |
| Total | 100 | 100 | 100 |

Solvent Adhesives for Peroxide Bonding

Solvent
PERCENT DRY WEIGHT

| Raw Materials | 8-4 | 8-5 | 8-6 | 8-7 |
|---|---|---|---|---|
| Phenoxy resin | 78.3 | 70.66 | 82.81 | 74.55 |
| (PKFE) | | | | |
| A2Bond | 14.46 | 16.3 | 11.46 | 13.75 |
| M-20 | 7.24 | 13.04 | 5.73 | 6.88 |
| (polybismaleimide) | | | | |
| Phenolic resole | | | | 4.82 |
| Total | 100 | 100 | 100 | 100 |

In this example, samples were tested via a hand/plier technique to speed up the process. Pliers were used to hand tear the rubber from the substrate and the percentage of rubber remaining was visually assigned. The best bond would be 100R or 100 percent rubber tearing bond. These results show bonding FKM to two different rigid substrates. The examples show adhesion to Kalix 9950 (polyamide/nylon) and zinc phosphatized steel (ZPS).

The following data illustrates effectiveness bonding a white FKM elastomer to different rigid substrates.

| Adhesive | Grit Blasted SS | Smooth SS | Kalix 9950 |
|---|---|---|---|
| 8-5 | 95R | 90R | 100R |
| 8-6 | 100R | 100CM | 100R |
| 8-3 | 70R | 95R | 10R |

The following three trials employ Adhesive 8-7 to bond a black FKM elastomer at a dry film thickness of 0.3 mils, compression molded for 7 minutes at 175° C. (347F).

| Adhesive | Zinc Phosphatized Steel | Grit Blasted Steel |
|---|---|---|
| 8-7 | 100R | 100R |
| | 100R | 100R |
| | 100R | 50,CM |

Additionally, Adhesives 8-4 and 8-1 were spray applied to zinc phosphatized steel coupons and a black FKM elastomer was compression molded for 7 minutes at 175° C. (347° F.), and demonstrated 100% rubber tear in a primary adhesion test.

In the following tests, an adhesive according to an embodiment of the present invention was prepared and use to bond HNBR to substrates to demonstrate the effectiveness of the adhesive on a second peroxide cured rubber (HNBR).

Aqueous Adhesive (HNBR Bonding)

| | Adhesive | Adhesive | Adhesive | Adhesive |
|---|---|---|---|---|
| | 8-8 | 8-9 | 8-10 | 8-11 |
| Phenoxy PKHW-35 | 29.8 | 19.8 | 14.8 | 27.3 |
| (phenoxy resin) | | | | |
| MDI-Uretdione | 30 | 30 | 30 | 30 |
| Heucophos ZPA | 0 | 0 | 15 | 7.5 |
| Bis-maleimide | 40 | 40 | 40 | 30 |
| Hisil 233 (Silica) | 0 | 10 | 0 | 5 |
| Marasperse (Dispersant) | 0.2 | 0.2 | 0.2 | 0.2 |
| TOTAL | 100 | 100 | 100 | 100 |

This study was completed to optimize the level of bismaleimide while holding the blocked isocyanate level constant. This study compared performance on both zinc phosphatized and grit blasted steel surfaces and also included a comparison of zero prebake and 2 minute prebake conditions. Adhesive 8-8 provided the best overall performance in this study. Silica appears to lower performance overall and again the Heucophos ZPA didn't add to the overall performance. Future studies will focus in the formulation space around Adhesive 8-8.

The adhesive was applied to the rigid substrate at a dry film thickness of 0.6-0.8 mils, dried, and HBNR was bonded at 340° F. (171° C.) for 14 minutes. The samples where then tested according to ASTM D429-B, modified to 2 inches/min at a 45 degree peel angle.

| | Adhesive | | Adhesive 8- | Adhesive |
|---|---|---|---|---|
| | 8-8 | Adhesive 8-9 | 10 | 8-11 |
| ZPS 0′ PREBAKE | | | | |
| Max Force PLI | 140 lbs | 90 lbs | 98 lbs | 76 lbs |
| % Rubber Retention | 20R | 5R | 8R | 3R |
| ZPS 2′ PREBAKE | | | | |
| Max Force PLI | 133 lbs | 83 lbs | 78 lbs | 71 lbs |
| % Rubber Retention | 50R | 5R | 5R | 2R |
| GBS 0′ PREBAKE | | | | |
| Max Force PLI | 142 lbs | 102 lbs | 123 lbs | 80 lbs |
| % Rubber Retention | 65R | 13R | 20R | 4R |
| GBS 2′ PREBAKE | | | | |
| Max Force PLI | 142 lbs | 88 lbs | 78 lbs | 73 lbs |
| % Rubber Retention | 78R | 5R | 5R | 4R |

### Example 9

The following example demonstrates the effectiveness of a solvent-based adhesive of an embodiment of the present invention wherein the adhesive a phenoxy resin, blocked isocyanate and propylene carbonate, and a water-based adhesive comprising a phenoxy resin, blocked isocyanate, silicone-modified polyurethane, and propylene carbonate. These adhesives are particularly effective for bonding TPSiV to aluminum and fiberglass.

| | Adhesive | Adhesive | Adhesive |
|---|---|---|---|
| | 9-1 | 9-2 | 9-3 |
| Phenoxy resin (PKHH) | 9.10 | 9.10 | |
| Phenoxy resin (PKHW-35) | | | 15.04 |
| MDI-Uretdione (Self-Blocked | | 3.90 | 6.27 |
| Isocyanate) | | | |
| Trixene BI7641 (DMP-Blocked | 6.50 | | |
| Isocyanate) | | | |
| Hauthane 2857 (polyurethane) | | | 3.51 |
| Propylene Carbonate | 28.55 | 24.00 | 14.76 |
| Dowanol | 28.55 | 35.70 | 1.84 |
| Water | | | 58.59 |
| Methyl Ethyl Ketone | 27.30 | 27.3 | |

Samples prepared according to the formulations above were coated on aluminum coupons, the adhesive dried, and TPSiV was injection molded onto the coated coupon.

| | Peel Strength (pli) | Rubber Tear (%) |
|---|---|---|
| Adhesive 9-1 | 24 | 45 |
| Adhesive 9-2 | 16 | 0 |

Samples were coated on glass fabric reinforced epoxy (fiberglass) coupons, the adhesive dried, and TPSiV was injection molded onto the coated coupon.

| | Peel Strength (pli) | Rubber Tear (%) |
|---|---|---|
| Adhesive 9-2 | 61 | 99 |
| Adhesive 9-3 | 63 | 97 |

What is claimed is:

1. An adhesive for injection or compression molding comprising a phenoxy resin and an organic carbonate.

2. The adhesive of claim 1, further comprising an isocyanate.

3. The adhesive of claim 2, wherein the isocyanate comprises a blocked isocyanate.

4. The adhesive of claim 3, wherein the blocked isocyanate comprises a self-blocked isocyanate.

5. The adhesive of claim 4, wherein the self-blocked isocyanate comprises a MDI-uretdione.

6. The adhesive of claim 1, further comprising a metal acetylacetonate.

7. The adhesive of claim 6, wherein the metal acetylacetonate comprises zinc acetylacetonate.

8. The adhesive of claim 1, further comprising a platinum catalyst.

9. The adhesive of claim 1, further comprising an organic carbonate.

10. The adhesive of claim 9, wherein the organic carbonate comprises propylene carbonate.

11. The adhesive of claim 1, further comprising a polyurethane resin.

12. The adhesive of claim 1, further comprising an allyl methoxy silane.

13. The adhesive of claim 1, further comprising bismaleimide.

14. The adhesive of claim 1, wherein the adhesive is free of any materials containing isocyanate functionality.

15. The adhesive of claim 1, wherein the polymeric constituents consist essentially of a self-blocked isocyanate, and phenoxy resin, and wherein the adhesive further comprises propylene carbonate, a water or solvent carrier, and optionally a catalyst or metal acetalacetonate.

16. The adhesive of claim 1, further comprising, a self-blocked isocyanate, platinum catalyst, carrier fluid, and optionally at least one of a metal acetylacetonate, allyl methoxy silane, or bismaleimide; wherein,
the phenoxy resin is present from about 5 to about 90 weight percent;
the organic carbonate is present from about 2 to about 25 weight percent;
the self-blocked isocyanate is present from about 1 to about 10 weight percent;
the platinum catalyst is present from about 0.01 up to about 1.0 weight percent;
the metal acetylacetonate is present up to about 10 weight percent;
the allyl methoxy silane is present up to about 10 weight percent;
the bismaleimide is present up to about 40 weight percent; and,
the carrier fluid is present from about 50 to about 90 weight percent;
wherein the amounts are based on the total weight of the adhesive composition as applied to a substrate.

17. The adhesive of claim 1, comprising a fluid carrier, 5.00 to 25.00 percent by weight of an organic carbonate, and the following components adding up to 100 percent by weight relative to each other, a phenoxy resin from 50.00 to 99.99 percent by weight, a blocked isocyanate from 0 to 10.00 percent by weight, a metal acetylacetonate from 0.00 to 5.00 percent by weight, and a platinum catalyst from 0.0001 to 0.70 percent by weight.

18. The adhesive of claim 17, in an assembly comprising a low temperature cured liquid silicone rubber bonded to a rigid substrate.

19. The adhesive of claim 1, comprising a fluid carrier, 5.00 to 25.00 percent by weight of an organic carbonate, and the following components adding up to 100 percent by weight relative to each other, a phenoxy resin from 50.00 to 99.99 percent by weight, a blocked isocyanate from 10.00 to 50.00 percent by weight, a metal acetylacetonate from 0.00 to 10.00 percent by weight, and a platinum catalyst from 0.006 to 1.00 percent by weight.

20. The adhesive of claim 19, in an assembly comprising a high temperature cured liquid silicone rubber bonded to a rigid substrate.

21. The adhesive of claim 1, consisting essentially of a phenoxy resin, organic carbonate, a self-blocked isocyanate, platinum catalyst, carrier fluid, and optionally at least one of a metal acetylacetonate, allyl methoxy silane, or bismaleimide; wherein,
the phenoxy resin is present from about 5 to about 50 weight percent;
the organic carbonate is present from about 2 to about 25 weight percent;
the self-blocked isocyanate is present from about 1 to about 10 weight percent;
the platinum catalyst is present from about 0.01 up to about 1.0 weight percent;
the metal acetylacetonate is present up to about 10 weight percent;
the allyl methoxy silane is present up to about 10 weight percent;
the bismaleimide is present up to about 40 weight percent; and,
the carrier fluid is present from about 50 to about 90 weight percent;
wherein the amounts are based on the total weight of the adhesive composition as applied to a substrate.

22. An adhesive for injection molding comprising a blocked isocyanate and a phenoxy resin, and optionally a metal acetylacetonate, and bismaleimide.

23. The adhesive of claim 22, wherein the polymeric constituents of the adhesive consist essentially of a self-blocked isocyanate, a phenoxy resin, and bismaleimide, and the adhesive further comprises a water or solvent carrier and optional filler materials.

24. A process for bonding an injection molded article comprising:
a) providing in an injection molding cavity a rigid substrate having an adhesive comprising a blocked isocyanate and a phenoxy resin applied thereto;
b) injecting into the injection molding cavity a liquid material at a temperature and pressure to allow the liquid material to flow and contact a portion of the adhesive-applied section of the rigid substrate; and,
c) maintaining the temperature and pressure sufficient to solidify the liquid material and form an adhesive bond between the material and the rigid substrate.

25. The process of claim 24, wherein the adhesive further comprises a platinum catalyst, organic carbonate, and water.

26. The process of claim 24, wherein the adhesive further comprises a metal acetylacetonate.

27. The process of claim 26, wherein the metal acetylacetonate comprises zinc acetylacetonate.

28. The process of claim 24, wherein the adhesive further comprises an allyl methoxy silane.

29. The process of claim 24, wherein the adhesive further comprises a metal acetylacetonate, bismaleimide, and water.

30. The process of claim 24, wherein the adhesive further comprises a silicone-modified, polyester-based, polyurethane resin.

31. The process of claim 24, wherein the liquid material comprises a high-temperature cured liquid silicone rubber.

32. The process of claim 24, wherein the liquid material comprises at least one of FKM, HNBR, or TPSiV.

33. The process of claim 24, wherein the rigid substrate comprises at least one of thermoplastic copolyester, polycarbonate, fiberglass reinforced polyamide, stainless steel, glass, or aluminum.

34. A process for bonding an injection molded article comprising:
a) providing in an injection molding cavity a rigid substrate having an adhesive comprising a phenoxy resin and an organic carbonate applied thereto;
b) injecting into the injection molding cavity a liquid material at a temperature and pressure to allow the liquid material to flow and contact a portion of the adhesive-applied section of the rigid substrate; and,
c) maintaining the temperature and pressure sufficient to solidify the liquid material and form an adhesive bond between the material and the rigid substrate.

35. The process of claim 34, wherein the liquid material comprises a liquid silicone rubber.

36. The process of claim 35, wherein the liquid material comprises a low-temperature cured liquid silicone rubber.

37. The process of claim 34, wherein the adhesive further comprises a platinum catalyst and an organic solvent.

38. The process of claim 34, wherein the rigid substrate comprises a polycarbonate substrate.

39. The process of claim 34, wherein the adhesive is applied to the rigid substrate and the solvent is evaporated prior to inserting the rigid substrate into the injection molding cavity.

40. The process of claim 34, wherein the rigid substrate comprises at least one of stainless steel, aluminum, thermoplastic copolyester, glass, polycarbonate, or polyamid.

41. The process of claim 34, wherein the liquid material comprises at least one of a thermoplastic silicone vulcanizate (TPSiV) elastomer, a hybrid of thermoplastic urethane (TPU) and crosslinked silicone rubber.
